(19) United States
(12) Patent Application Publication
(10) Pub. No.: US 2016/0006851 A1
(43) Pub. Date: Jan. 7, 2016

(54) Cellular telephone docking interface

(71) Applicants: Joe Born, Lincolnwood, IL (US); David Phillips, Lakespur, CA (US); Ari Krupnik, Sunnyvale, CA (US)

(72) Inventors: Joe Born, Lincolnwood, IL (US); David Phillips, Lakespur, CA (US); Ari Krupnik, Sunnyvale, CA (US)

(21) Appl. No.: 14/685,256

(22) Filed: Apr. 13, 2015

Related U.S. Application Data
(63) Continuation of application No. 13/113,254, filed on May 23, 2011, now abandoned.

(51) Int. Cl. H04M 1/725; H04B 1/3883; H04W 8/20; H04M 1/04

(52) U.S. Cl. CPC H04M 1/7253; H04M 1/04; H04B 1/3883; H04M 1/72527; H04W 8/20

(57) ABSTRACT

A cellular telephone interface and generalized dock that is particularly adapted for use with ANDROID™ telephones which can also connect a wide variety of other mobile telephones to different types of docks, alarm clocks, music platforms and other external devices. Data and audio can both be transmitted via the telephone's headphone jack through a single cable supplying an audio path for playing music and other audio applications as well as a data path for control. An API can be supplied to run on the telephone that allows user applications to interface a wide range of docking and control functions. The API provides a command set with commands that can control a generalized dock and monitor its status.

### BACKGROUND

1. Field of the Invention

The present invention relates generally to electronic equipment interfaces and docks and more particularly to a cellular telephone interface and docking unit that can dock a wide variety of cellular telephones.

2. Description of the Prior Art

Portable devices, speakers and docks for portable electronic equipment such as digital media and audio players, including so-called MP-3 players, are known in art and have been very popular with consumers. Such devices have ranged dramatically in price, quality and functionality. The simplest have been battery or wall-powered speakers connected to the portable player solely by a 3.5 mm stereo headphone jack. Recently, more advanced devices have come into the market with proprietary connectors that allow charging and control of the device as well as providing speakers. Some of these devices have had remote controls.

The demand for devices has continued to increase with the proliferation of digital and portable media applications and services that have been incorporated into cellular telephones, particularly a new type of so-called “smartphones” that offer computer-like power and functionality. The capability of these devices has increased to include a variety of new applications and services including, but not limited to, streaming music and media services, which operate to provide online radio, on-demand and streaming music and recommendation services as well as on-demand and streaming video, TV and movie entertainment. Such applications and services not only make enjoying media and music more convenient, but also “socialize” digital media and music enjoyment by enabling users to discover and find more information about media and music, such as, artists or songs, receive recommendations based on similar songs or artists as well as communicating with friends and family about songs.

A great disadvantage of certain media and music devices, such as those operating on the Android platform is their fragmented nature arising from a lack of standard interfaces. In contrast to this fragmentation, Apple Corporation has produced a line of devices with a unifying interface and a single standard proprietary connector (iPod™, iPhone™ and iPad™). The Apple connector allows docks which include remote controls and buttons that permit the device to act as a stereo of sorts as well as an alarm clock. However, outside of Apple, there is no single standard for either interfaces or connectors that spans all phones, even among those using the Android platform. Furthermore, many of the connectors do not allow control of the device at all, such as USB, which often only allows charging of the telephone or charging coupled with file transfer to a PC.

It would be particularly advantageous to have a universal docking device that would interface with a wide variety of cellular telephones, especially those telephones known as ANDROID™ phones.

Many cellular telephones and smartphones have a wireless interface that follow the BLUETOOTH standard. This is generally used to convey telephone audio to and from a wireless earphone and microphone, and it is also used to send wireless stereo to a headset. BLUETOOTH interfaces sometimes can control the telephone, and hence could be used to interface with a dock. Various wireless headsets use BLUETOOTH to control the telephone. However, this technology has a number of disadvantages for digital music. First, BLUETOOTH is relatively expensive and uses considerable power (which can reduce battery life). The increased power consumption has induced some users to disable BLUETOOTH on their phones. BLUETOOTH also requires a protocol known as pairing which increases the complexity and risk of functional error. Paring complexities and malfunctions can occur when a user pairs with multiple accessory devices and docks (such as a stereo headset).

In addition, BLUETOOTH has limited range (typically 30 feet or less), is subject to frequency interference and can result in diminished audio fidelity depending on the degree of compression. A final problem is the fact that BLUETOOTH will introduce a latency in the signal where video (displayed on the phone display) and audio (beamed to a remote device) will be out of synch.

When used in an automobile to play music for a car stereo system, some of the limitations of BLUETOOTH become even more pronounced. The additional power consumption of BLUETOOTH typically requires the phone to be plugged in for charging, thereby eliminating much of the benefit of a wireless connection. Furthermore, BLUETOOTH usually does not allow the transmission of metadata (title, artist, album, etc.) for the display on the car stereo. Furthermore, most, if not all Advanced media controls, from simply pausing to music navigation such as choosing a new playlist or selecting a different Internet station, will require concentrated interaction with the handset which is illegal while the vehicle is in motion in many states.

It would be advantageous to have a dock that did not require using BLUETOOTH for its main interface and control, but instead provided a wired connection and physical buttons which allow basic media controls that can be easily and safely operated while driving a vehicle.

The most common connector found on many devices (including virtually all mobile telephones) is a headphone jack. Generally this is a 3.5 mm insert connector that contains conductors for both headphones (either in mono or stereo) and a microphone. It would be advantageous to have a mobile telephone or electronic device dock that is controlled by the ubiquitous headphone jack.

Prior art docks generally have lacked sophisticated software that allows unification of user preferences and metadata across disparate digital media and music applications and services. Prior art docks also have not allowed a button push on the dock to activate a global action such as activating gathering data from remote servers to build up preferences such as playlists or similar data collections. It would be advantageous to have dock system where a button press on the dock, or on the dock's remote unit, leverages a supporting software library and application on the cellular telephone to gather metadata and forward this information to one or more remote servers in order to collect, organize and share preferences such as playlists and the like.

### SUMMARY OF THE INVENTION

The present invention relates to a cellular telephone interface and generalized dock that is particularly adapted for use with ANDROID™ cellular telephones (mobile telephones that use the ANDROID™ platform); however, it can also interface a wide variety of other mobile telephones that use various cellular telephone platforms to different types of docks including alarm clock docks, audio and video platforms and other external devices. Data and audio can both be transmitted via the cellular telephone's headphone jack through a single cable providing an audio path for playing music as well as a data path. An API (application programming interface) can also be supplied to run on the telephone to allow user application developers to interface a wide range of docking and control functions to their particular user Apps (applications). The API provides a command set with commands that can control a generalized dock, with or without an alarm clock and other features, and also monitor its status. Typically an application can be provided on the telephone that directly interfaces the data channel between the telephone and the dock to allow seamless access to the dock by the API and hence user Apps. A user library can be supplied as well. The dock unit can provide charging current for the telephone typically through the USB port with a second cable. The dock unit also typically contains several control buttons that can be made to mimic keys on the telephone by using the supplied application on the telephone. A handheld remote can optionally be used with the generalized dock to also provide remote control functions. Button pushes on the dock or on the dock's remote unit can perform global actions such as “global metadata capture” to a remote server. In this way, the button push leverages the position of the dock and its accompanying supporting library and configuration App to gather media metadata and forward this to a remote server, thus allowing the collection of playlists and the like.

### DESCRIPTION OF THE FIGURES

Attention is now drawn to several drawings that illustrate features of the present invention:

FIG. 1 shows a front view of an embodiment of a dock according to the present invention.

FIG. 2 shows a back view of the embodiment of FIG. 1.

FIG. 3 shows a different embodiment of a dock with larger speakers.

FIG. 4 shows an embodiment of a handheld remote unit that can control the dock.

FIG. 5 shows a block diagram of an embodiment of the invention.

FIG. 6 shows with hidden lines how a telephone can fit into the dock and where cables can be located.

FIG. 7 shows a dock that contains finger elements that automatically engage a telephone.

FIG. 8 shows how a button push on a remote unit can gather metadata and forward that to a remote server.

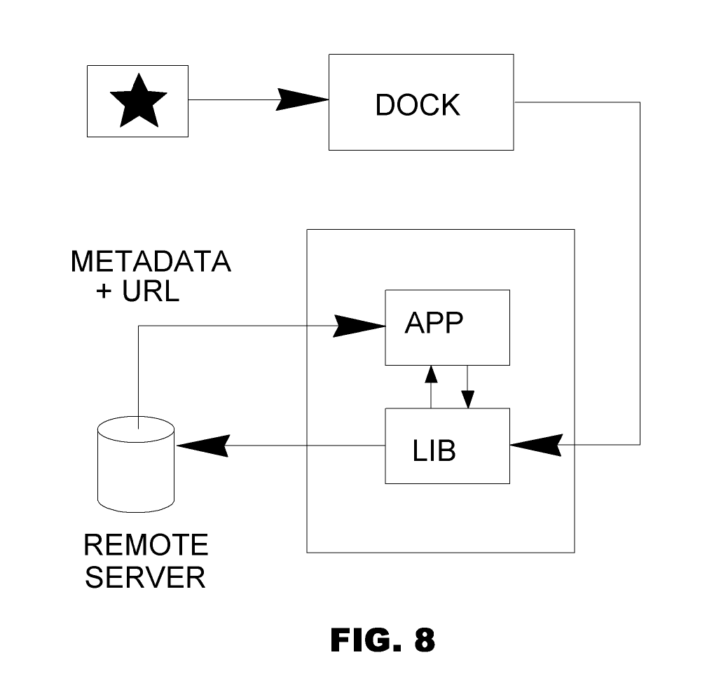

While several drawings and illustrations have been presented to aid in understanding the present invention, the scope of the present invention is not limited to what is shown in the figures.

### DETAILED DESCRIPTION OF THE INVENTION

The present invention relates to a standardized interface and cellular telephone dock that allows various mobile telephones and other electronic devices to communicate with and control devices such as cellular telephone audio speaker docks, alarm clocks, video, audio and music players and many other devices. In particular, the interface of the present invention is compatible with the ANDROID™ platform. The present invention also allows button pushes on the dock or a handheld remote unit associated with the dock to perform global metadata capture to the cellular telephone and a remote server thereby enabling user preferences and behaviors regarding media to be captured and organized across disparate applications and services allowing for unified management of media and communications.

Various parts of the invention can be bundled to create a standard interface (which can be called SONR). The parts typically consist of: 1) a cellular telephone software library, configuration and management App and API that resides on the telephone, 2) a microcontroller unit (MCU) in a dock or other external device; 3) a device protocol, 4) a mechanical interface between the cellular telephone and the external device, 5) the specification of buttons for device and remote control, and 6) media player, alarm clock and other applications residing on the telephone.

While a dock that can contain an alarm clock is one example, the present invention covers a much wider scope of devices by providing an API on the cellular telephone for an App developer that is guaranteed to work on external devices, such as cellular telephones on the Android platform, from many different manufacturers. Such external devices can include alarm clocks, speaker docks, desktop docks, entertainment, music, and conference call devices, automobile mounted docks as well as many other external devices. Such devices may also include speakers, microphones, displays and input and output interfaces that allow interaction with a variety of additional devices, including external speakers, television displays, etc. The present invention provides a single hardware protocol for device makers that will work among a catalog of compatible Apps. The present invention moves beyond docks that simply provide a set of speakers and a basic remote for controlling media and music. Application developers under the present invention have access to controls for navigation and interactive functionality. Numerous applications can be created using these tools.

Although there are a variety of potential use cases for the dock of the present invention, a particular case that the dock application and remote unit is particularly well suited to support is the casual background audio user or music listener. While a more involved user may want to carry their phone to interact directly with the phone's services and applications, the casual user who wants to more closely approximate the experience of a home stereo system may desire to have to the phone physically removed from their person, and may further wish to interact with the phone and audio playing device, but in a more casual, simplified and limited way. Through the separation of the phone from their person, and simplified dock buttons and remote control functionality, they may find they are better able to concentrate on the people within their physical proximity which may often include close friends or family members. While they may not desire deep concentrated interaction with the cellular telephone media and music applications and audio stream services and their myriad of interactive menus and options, they may still wish to maintain some control over it. For example, such interaction can include simple volume control as well as media controls such as Pause and Forward. Simple book-marking of favorite songs or artists or the notation of preferences, such as Like or Dislike helps improve the suitability of recommendation-based Internet streams or other recommendation algorithms. Some advantages provided by single button control of present invention to casual listeners are as follows:

1. It is easier to operate and vastly less distracting. A Favorite or Like button can be initiated with a single click of the remote control, unlike digging endlessly through menus which may include vast troves of irrelevant information and options regarding the song, artist, etc. The latter information typically requires a degree of focus from the user thereby diverting attention from surrounding situation or people to the cellular smartphone screen. In some situations, such as while driving, interaction with the phone display may actually be dangerous and illegal.

2. It is vastly faster. Operations such as Fwd or Mute can be initiated within one or two seconds of possession of the remote control. These operations are almost always much slower on the actual device which regularly goes to sleep, locks the screen, obscures the media controls in favor of less pertinent information, and the like.

3. It can be performed without looking at the display. Because the dock and remote control have physical buttons typically, interaction can be done entirely by feel. This is, of course, vital in those situations, such as driving, where diverting attention from the task at hand is dangerous. Even when at home, this can be an advantage. If engaged in conversation, for example, It is vastly less disruptive to the conversation. Rather than remove focus from the person being physically interacted with, a single click of a remote key, to skip or favorite a song, can be done without even looking at the remote.

4. It provides additional utility by allowing the user to charge their phone in the dock while still using it for entertainment or other functional purposes (such as speaker conference calls).

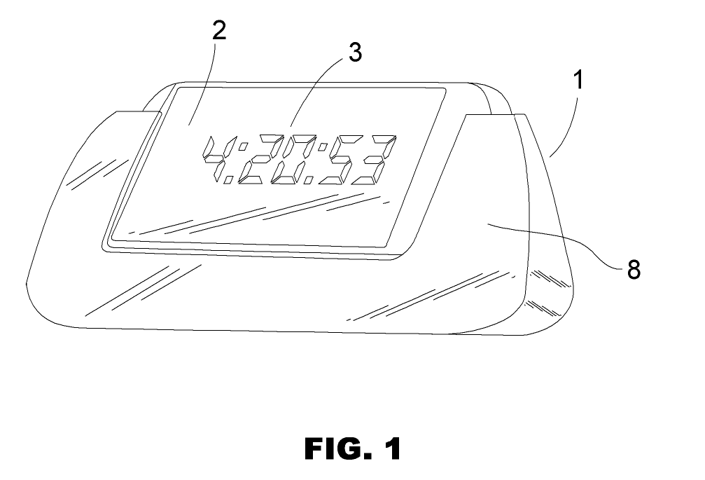

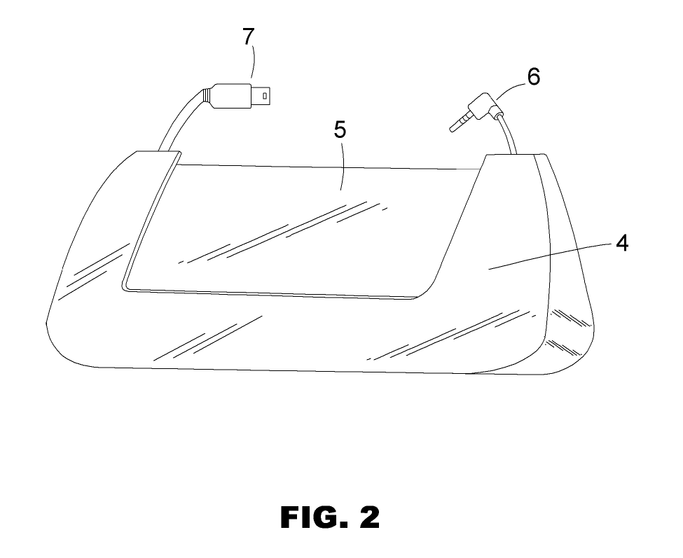

A particular embodiment of the present invention is an alarm clock dock such as that shown in FIG. 1. FIG. 2 shows a back view of the embodiment of FIG. 1. A docking platform 1 receives a cellular telephone in a slot 5 with a hollowed out area 4. A USB cable 7 attaches to the USB port on the phone, and a phone jack cable 6 attaches to the telephone phone jack. A set of speakers 8 can provide music and other sound output such as a alarm clock alarm. A panel 2 typically contains a clock 3 which can be an alarm clock. The headphone jack on the headphone cable 6 is usually a 3.5 mm standard connector with four conductors (ground, ch.1, ch.2 and microphone). The telephone's headphone jack can be located in any location on one of the sides of the phone. The USB connector on the USB cable 7 can be a Micro USB jack. The USB port on the telephone can be located on any of the sides. No further connections between the dock and the telephone need to be made.

The dock 1 can accommodate different sizes of telephones. Preferred dock dimensions (dimensions of the mechanical telephone receiving slot on the dock) are length between 124.5 mm to 116.8 mm, width between 58.4 mm and 66.0 mm and slot between 12.5 mm and 20.0 mm. While these dimensions fit most present mobile telephones, other sized telephones may appear in the future. Any dimensions needed to fit any telephones or other mobile devices are within the scope of the present invention.

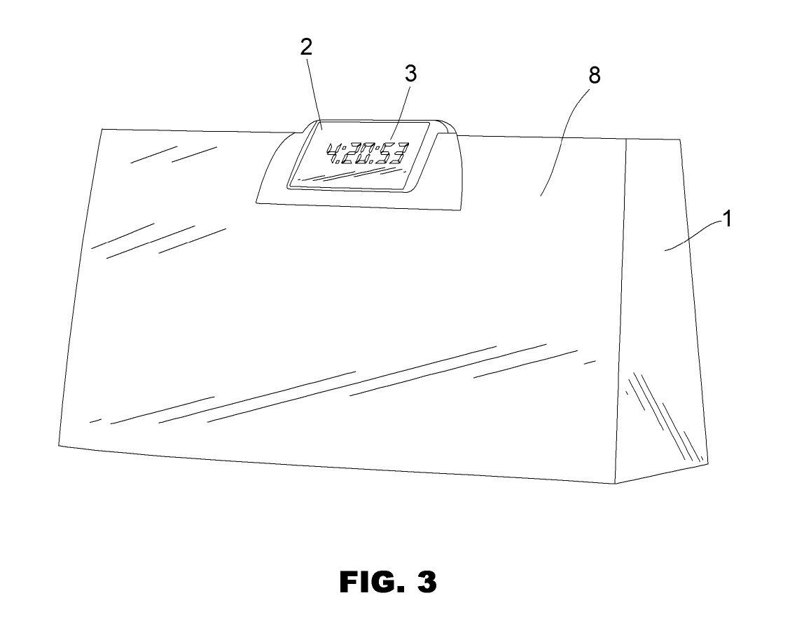

Various dock exterior shapes and configurations can be used. FIG. 3 shows a unit with much larger speakers 8 (for better sound quality) along with a smaller panel 2 and clock 3. Various configurations of docks may not even include clocks, but rather might include entirely different electronic units or functionality. Any particular dock can optionally include a variety of control buttons or even a LCD screen allowing for the display of time or the viewing of metadata (e.g. artist, song name).

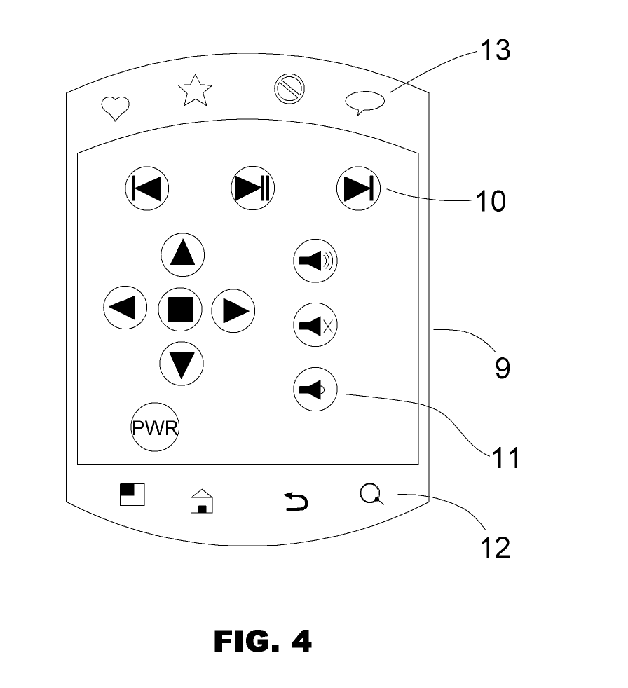

In certain embodiments of the invention, a particular dock or external device may be equipped with a handheld remote unit 9. FIG. 4 shows such a possible handheld remote. Several different sets of keys appear on this remote shown in FIG. 4 in four groups. The top group 13 contains keys that can be assigned to various tasks under control of the designer. For example, a heart button can indicate “Like”; a ban button can indicate “Dislike”; while a star button can indicate “Favorite”. The second row of keys 10 can be keys that relate to playing music such as forward, reverse and fast forward. The central key cluster 11 can contain keys that relate to sound control and volume. The last group of keys 12 can relate to data and browsing if desired by the designer. The remote can contain a complete set of navigation keys. The remote and key combinations shown in FIG. 4 are for illustration only. Any number of keys, types of keys, number of rows, and combinations of keys are within the scope of the present invention. The present invention allows a designer to innovate on both the types of keys and the number of keys that might appear on a remote. Several possible keys and their uses are as follows:

### Power Button

This key toggles the amplifier/speaker power on and off and toggles between two states:

On state: amplifier is on; smartphone is in “docked mode”

Off state: amplifier is off; smartphone is in “charging mode”

### Favorite Button (Star)

The “favorite” button can be used by listeners looking to record and organize preferences regarding of media such as artists, album or song titles without a great deal of focus on or interaction with the device. By its very nature as a hardware fixture, the favorite button is well positioned to provide a function that bridges multiple Apps and services, consolidating favorites and preferences from multiple sources and services. In addition to standard functionality described below, by user configuration, the button press may simply pass along the favorite request to an active application which may have its own set of functions as determined by the application developer.

Default behavior for the Favorite function can be as follows:
1. If a media object, such as for example, a song is playing, the SONR app will get the identity for that song.
   1. if App gives the metadata via “scrobbling” or some other interface, than the app can receive it the same way.
   2. If the app only gives only related information such as the title of a video without metadata information, the app can use a “guessing” algorithm to give a best guess as to song title based on text in title.
   3. App “scraping” (intercepting text sent to the screen) can be used on some smartphone platforms that allow it.
   4. Alternatively, the App can actually intercept the audio stream coming from the App and do a digital “fingerprinting” operation to identify the song.
2. If a song is not playing, the SONR App can capture an audio sample from the ambient sound (presuming that the listener is wishing to identify music from a source other than the smartphone itself). Alternatively, if the dock contains an FM (or other) radio, and that radio is on, then the dock could capture an audio sample from that radio (or otherwise receive song title and artist information).
3. Once song data is captured or guessed, that information can be forwarded, along with media location information to the SONR server. The media location information is the information that indicates where the media resides. The media could reside on the user's device or it could be elsewhere on the web in any remote location.
   1. A variety of “crowd-sourced” or other methods can be used to allow the establishment of a large, refined database of available, on-demand sources for songs. For example, a button allowing a user to “find this song on the Internet” within their favorite playlist might be employed, and if the server were to determine that a number of legitimate users were selecting a given link as associated with a given song, it could be surmised that link is accurate. Such crowd-sourcing or manual techniques are well known in developing such databases.
   2. The SONR service should be authenticated using a username and password stored in the App and maintained as a private list.
4. Subsequently, the user can browse and play items from the “Favorite” list from a variety of potential sources. It should be noted that not all sources can either accept instructions from a third party, nor play music “on demand”. Thus the App may have an algorithm that allows it to make alternate arrangements. For example, a selection received from a streaming service may not be available to play a) on demand or b) within the “confines” of a playlist within the App. Therefore, it may be desirable that the App may contain an algorithm that, in consideration of the above factors, causes the App to seek alternative sources for the media's playback or related media. Naturally, if that particular song was available from the media locally available on the playback device itself that could be used, but as an alternative, it could be found on a cloud-based streaming or on-demand service. Such options can be configurable based on user preferences or behaviors, availability of services and network connectivity. Some users may want to buy songs from a given service, while others have subscribed to an on-demand streaming service. Still others may simply want to scan online sources for available songs, while others may want to ignore all songs for which exact matches cannot be guaranteed.
5. The SONR server could also expose the favorites collection via web service or API to other applications as well, thus allowing the playlist (and associated media location) to become available for other applications, or of course, viewable as a website itself. Other applications could take that information and use it in a variety of different ways. The following are several application examples given to aid in understanding the present invention:
   Application example #1: An App could take the information from a favorite list and use that information to tailor recommendations based on that list. This could be done using a cloud streaming service such as Pandora™ or Last.fm™ or it could be done using local media such as Apple iTune's™ genius feature that creates playlists based on favorite songs.
   Application example #2: An App could take the information from a favorite list and use that information to recommend similar artists and songs that the user may wish to buy.
   Application example #3: An App could take the information from a favorite list and use that information to recommend other people with similar tastes or even DJs or other sources of personal playlists (and music). The user may then wish to listen to a radio station or playlist from that person.
   Application example #4: An App could take the information from a favorite list and tailor information to the user including information about upcoming live
   events, discography, fan and community sites, official artist sites, and those providing free music.
   Application example #5: An App could take the information from a favorite list and provide links to lyrics for the listed songs.

### Share

Like the Favorites button, the Share button can be configurable by user preferences. In addition to the standard functionality discussed below, the button press may simply pass along the Share request to an active application, which may have its own set of functions as determined by the application developer.

The Share functionality by default can be the same, or very similar, as the favorites button except that it is visible publicly rather than privately as is the case with the favorite list. Of course it is possible for the user to configure from the App or website how “public” the shared list is (analogous to the behavior of posting on other social networking sites such as TWITTER™ or FACEBOOK™ where users can allow public posts to be visible by friends, by everyone or only by selected users.)

Because it is the nature of the dock that it facilitates the more casual and simplified interaction of users with their media and music (such as would be appropriate at the dinner table or other situations where the engagement is complimentary to the media entertainment and/or music listening experience), default configurations can be established ahead of time so that the share button works with a simple click of the share button and will not require additional interaction with the device such as confirmation menus or other queries.

There are a variety of options that the user could apply to their “share” behavior, which would allow them to edit and manipulate such a list outside of the dock when they may desire to be more focused on the playlist. They can refine, organize and correct the list. This can be done from an application or from the web itself. A tagging mechanism that would allow the user to customize sharing sets such as segment visibility by users or to organize music by genre types can be used.

Examples of a shared list:

### Example #1

An App can be directed to another users playlist and the present user could listen to the “shared” music from that user, be it a friend or other trusted source. The playlist can literally reflect those songs posted by a friend, with those songs for which there is no reliable source omitted, but it is also possible that the playlist might be an interpretation of that list with recommendations of similar songs or artists added or substituted to the mix.

### Example #2

The user can use the favorites page as personal favorites playlist that they could link to from personal sites on the web or on social networking sites. Such a page might appear as http://www.sonrdigital.com/username where “username” is the user's user name.

### Example #3

The user can use the Favorite button to post links directly to social networking sites as “status updates.” which would appear and be visible to those friends that have connected to them there.

### Example #4

The user can use the Favorite button to post to a music-on-demand site which would allow registered friends to listen to the posted tracks within their service. This example is very similar to Example #2, except that it demonstrates a third party site linking to the metadata service and replacing the location information with its own track and title location information (based on the song title and artist metadata information).

### Thumbs Up “Like” Button

The Like button is anticipated to pass along the Like button event directly to the application where it will be acted up internally by the application. Typically this can be used for signaling to a streaming radio application that this song is desired to be played more frequently or more like it are to be played. Other applications include adding a star to songs stored locally so they can subsequently be included in from automatically generated playlists based on “most liked” songs.

### Thumbs Down “Ban” Button

The Ban button can pass along the Ban button event directly to the application where it will be acted up internally by the application. Typically this can be used for signaling to a streaming radio application that this song is desired to be played less frequently or to be avoided altogether. Other applications include removing a star from songs stored locally so they can subsequently be removed from automatically generated playlists based on “most liked” songs.

### Home Button

The Home Button generally takes the user to the “Dock Home” which provides the user with a short list that gives easy access to multiple appropriate music Apps with streamlined navigation and selection (i.e. it can provide a short list of applications with large fonts so as to be navigable across the room). Such a list should be configurable by the user.

### Search Button

The search button can initiate a voice search for media when the user speaks a term into the phone. The App can search for that term on local media and those services to which the user subscribes. For such applications, the built in microphone on the cellular phone may be used, or it may be advantageous to have the dock provide a microphone which will allow improved input from speakers across the room.

### Menu Button

This button can perform just as the menu button on the phone itself does. Typically providing additional “menu” and of configuration options to the user pertinent to that App.

### Back Button

This button can perform just as the menu button on the phone itself does. Typically providing backwards navigation to move to the previously shown screens of the App.

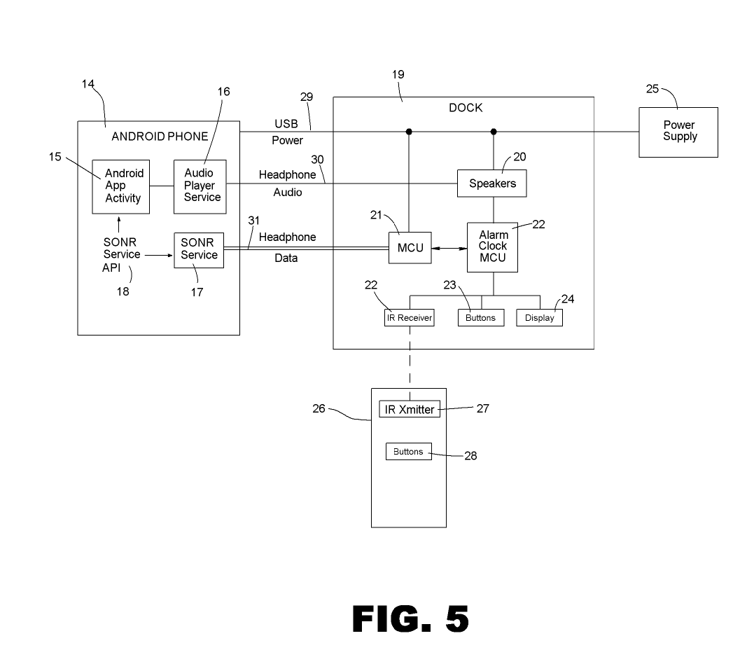

Turning to FIG. 5, a typical dock can be seen which can be a speaker dock that receives an ANDROID™ platform telephone. According to the present invention, the “Android phone” 14 (named because it is built around the ANDROID™ platform) contains an Android App activity interface 15 and an audio player service 16 that interfaces audio supplied by the telephone into the telephone's headphone jack. The present invention typically supplies both a Service API 18 and a Service module 17. The App developer can use the supplied API to interface applications to an external device using the SONR concept. The API contains specialized method calls that the App can use to cause the Android platform to perform tasks related to the dock or other external device. Some of these functions route commands to the dock, while others receive status indications from the dock.

The telephone 14 is usually connected to the dock 19 by a USB cable 29, which in a preferred mode is used only to charge the telephone's battery. It should be noted that while the preferred mode is to use the USB cable only for power, in other embodiments of the invention, the USB cable may also be used for data. Any use of the USB cable is within the scope of the present invention. The other connection between the telephone and the dock is a cable that plugs into the telephone's headphone jack. Here two channels of audio 30 run from the phone 14 to the dock 19, and a serial data channel 31 runs between the phone 14 and the dock 19 using the microphone (data from the dock to the phone) conductor and one or both of the headphone (data from the phone to the dock) conductors. As with the USB cable, the headphone cable and jack may be used for any type of audio, video or data communication in various embodiments of the present invention.

A preferred serial communications format is 2400 bits per second using 8 data bits, no parity bit and 1 stop bit. Any other serial communications format may be used. The preferred electrical signal is non-inverting TTL style signal with a high level of around 2.8 volts and a low level around 0 volts. With current telephones, 2.8 volts is the normally highest voltage that the audio input to the phone can tolerate. Nevertheless, any other electrical signal that the telephone can tolerate may be used. A preferred command format uses of one or more ASCII characters followed by a terminator. A separator can be used to separate a command from its arguments. In a typical protocol, any command that is not understood by the recipient can be ignored. Because of the close range and high signal levels at the ports, checksums, parity bits and the like are generally unnecessary. However, the scope of the present invention includes checksums, error correcting codes, parity bits, message identification and counting and any other data protection and transmission scheme including retransmission on errors.

The dock 19 is typically connected to a power supply 25 that powers the dock and, as previously explained, also provides charging current to the telephone through the USB cable 29. The power supply 25 generally needs to supply between 500 mA and 1 A at 5V to charge the telephone. A small, plug-in power supply known in the art can supply this power.

The dock normally contains a microcontroller (MCU) 21, speakers 20, an alarm clock 22, a display 24 and buttons 23. While all of these features are shown in the figures, any of them can be optional with the present invention. The MCU 21 in the dock can communicate with the service library stored in the telephone through the headphone jack data channel previously described. Generally, a supplied App in the telephone communicates with the dock via the library and the API, and the dock communicates with the telephone via the protocol described.

In addition, if a handheld remote 26 is used with the dock, the dock can contain an infrared (IR) receiver receiving light signals from an IR transmitter 27 in the remote 26. The remote usually also contains various buttons 28 (as is shown in FIG. 4). A preferred number of buttons is around 20.

In the dock 19, the MCU 21 can coordinate the settings of the clock 22, the buttons 23 and a display 24 if present. The MCU 21 can also control features associated with the speakers 20 such as volume, separation and the like. The dock itself can typically have four or more buttons such as play/pause, forward, back and snooze (clock function). Any number of buttons may be used on either the remote or the dock. Depressing buttons on the dock or on the handheld remote can mimic similar key presses on the phone through the supplied App and the API.

A potential compliment to the above would be to emulate the signals powering the inline wired headphone remote control found on many phones. Such inline remotes allow control of such basic functions as play/pause and would allow the dock to have at least basic functionality for those phones for which an app is not available, such as those not running Android as a possible example. Although most functions would not be available using such emulation, it would at least provide rudimentary controls for those phones that would otherwise have no control at all.

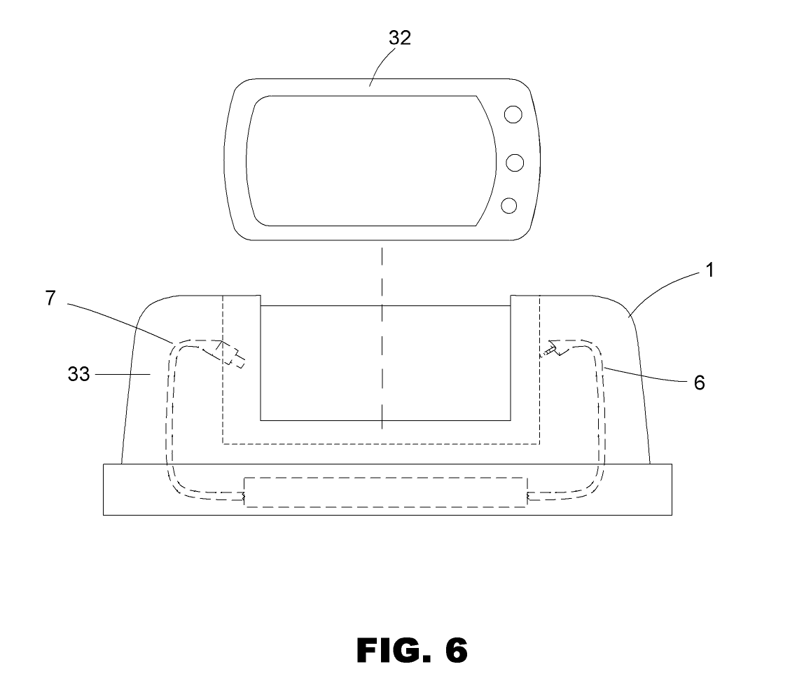

FIG. 6 uses hidden lines to show the location of the slot 4 that receives the telephone 32 as well as the location of the cables 6, 7 inside the dock compartment 33. The telephone 32 is normally laid on its side so that the audio jack and USB port are accessible (not on the down side). The cables are pulled out of the dock and connected to the telephone, and then the phone 32 is slipped all the way into the slot 4 where it is held by gravity or otherwise.

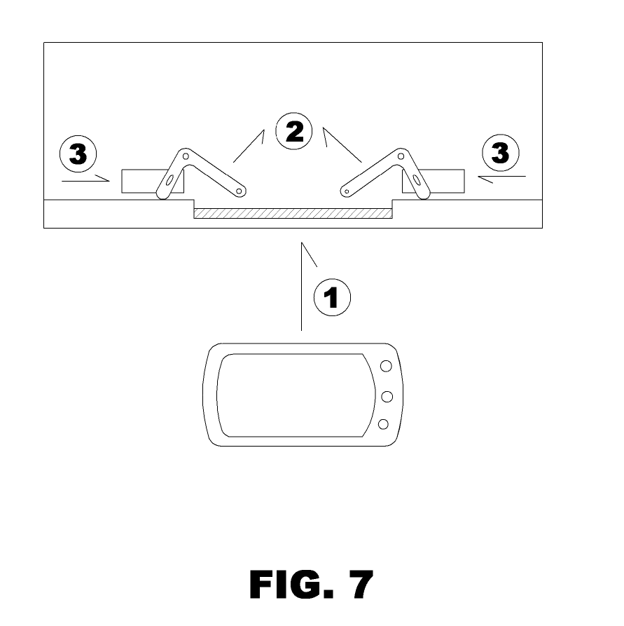

FIG. 7 shows a type of dock that has mechanical fingers 40 that deploy and engage a telephone the is inserted in the dock. These fingers 40 generally attach electrical connections into the earphone jack and the USB port of the telephone.

### Bidirectional Communication

As stated, the API and communications App on the telephone support bidirectional communication between the telephone and the dock.

### Commands

Numerous command sets can be used to communicate bidirectionally between the dock and the telephone. Functions of some of these commands have been discussed in relation to a remote unit. The buttons that activate these commands can be on the dock, on the remote unit or on both. The following can be included:

### Dock to Telephone

Play_Pause starts or pauses playback.
Fast_Forward advances forward in the current track.
Rewind reverses back in the current track.
Track_Forward skips to the next track.
Track_Backward skips to the previous track.
Volume_Up steps the volume up by 1 unit.
Volume_Down steps the volume down by 1 unit.
Mute—mutes or un-mutes the audio.
Like—sends “like” signal.
Dislike—sends “dislike” signal.
Favorite—sends “favorite signal.
Share—share current track with friends.
Snooze—interrupts playback for 9 minutes.
Preset_{—}1 . . . Preset N—user configurable playbacks.
Up—up navigation button.
Down—down navigation button.
Enter—enter navigation button.
Menu—replicates menu button on phone.
Home—replicates home button on phone.
Back—replicates back button on phone.
Search—replicates search button on phone.

### Telephone to Dock

Time HH MM SS—sends current time to clock.
Alarm_a HH MM SS—sends A alarm time to clock.
Alarm_b HH MM SS—sends B alarm time to clock.

These examples of commands have been given to illustrate the types of commands that can be used. Any of these commands may be omitted, and any other commands may be added to any implementation of the present invention as needed. Any command set is within the scope of the present invention.

### Application Interface API

The API can implement a Dock object which is a software representation of a hardware dock that communicates with the telephone. Application programs running on the telephone can call methods belonging to the Dock object. The implementation of the present invention translates these calls into physical actions in the dock hardware. Apps on the telephone through the API can also register CommandListeners on a Dock object to which are responsive to physical actions taking place on the dock such as button pushes. For example, if the user presses the snooze button on the dock, the dock control application (running on the dock MPU) can call something like: {@link Dock.CommandsListener#snooze( )}. The open CommandListener on the telephone then can notify the running App that the snooze button has been pressed. Typically software supplied with the SONR application on the telephone will directly translate button presses on the dock to OS-level calls that emulate corresponding actions on the phone. Applications may, if they choose to, provide their own implementations of these interfaces that intercept these button presses and perform custom actions in response to them.

As an example of use of the API, several method calls will be demonstrated:
1) An application running on the telephone wanting to set the clock on the dock could call a Dock method such as: public void setTime (int HH, int MM, int SS);
2) To set up a listener to receive notifications of button pushes on the dock that relate to playback control: public void setPlaybackCommandsListener(Dock.PlabackCommandListener listener);
3) An event such as: public void playPause ( ); would signal a push on the playback/pause key on the dock; the App on the phone could take appropriate action.

The present invention relates to a complete system for interfacing with external devices that can dock to a mobile telephone, especially an Android phone. The preferred method of communication is through the telephone's headphone jack; however, a USB data channel or a wireless data channel (such as BLUETOOTH) can also be used, most phones today do not have a good data interface into the USB, and as previously discussed, wireless methods are complex and generally use too much power. The cheapest and easiest to implement is the headphone jack cable.

As previously stated, the present invention typically contains a supplied control App running on the telephone along with a supplied API that allows user development. A dock typically contains an MPU and one or two speakers as well as an optional alarm clock and buttons. The dock can be remotely controlled with an optional handheld remote unit. The various combination of features that appear on any particular dock or other external unit can be varied according to the designer's wishes.

### Dock Telephone Application

The Application in the telephone that controls the phone dock is uniquely positioned to have global functionality. For example, it is natural both from a technical standpoint, as well as from a user expectation, that the dock application controls the functions of the various dock buttons. As a result, the dock application is uniquely positioned to function as an intermediate in bridging certain functions among applications. The Favorites and Share buttons lend themselves naturally to an application and service that consolidates user favorites among various services. Users typically have global favorite songs that span all the services they listen to, not just favorite songs within a particular service. Likewise since users typically do not have favorite songs for a given device, but rather favorite songs across all devices, a cloud service, or the like, can be connected to the App that allows such a list to be shared across devices and with other friends.

The application typically has several functions:
1. It provides a home page App that allows shortcuts to the various Apps a user may want to use from the dock.
2. It handles and interprets button presses passing them along to the appropriate application or taking its own action.
3. It communicates certain button presses along with media metadata to a remote server.

FIG. 7 shows schematically how the dock and App communicates and how certain song metadata can communicated to a remote server. For example, the Star (Favorite) button is pushed on the dock. This is communicated to the dock typically using IR light. The dock, using the communications methods discussed above, causes a the control App in the telephone to interact with a stored library and to get metadata from an external server. This operation allows creation of lists as has been previously discussed.

Several descriptions and illustrations have been provided to aid in understanding the present invention. One with skill in the art will realize that numerous changes and variations can be made without departing from the spirit of the invention. Each of these changes and variations is within the scope of the present invention.

We claim:

1. A mobile telephone docking system comprising:
a control application adapted to be stored and execute on a cellular telephone;
an API also executable on a cellular telephone that provides a command set to a user application, said command set containing commands relating to a dock unit external to said cellular telephone;
a dock unit adapted to physically receive and hold a cellular telephone, said dock unit providing charging current to the cellular telephone and a bidirectional data communications path between the dock unit and the cellular telephone;
said dock unit also providing an audio path between the cellular telephone and the dock unit;
said bidirectional data communications path and said audio path both using a single headphone jack on the cellular telephone.

2. The mobile telephone docking system of claim 1 wherein said charging current flows through a USB port on said cellular telephone.

3. The mobile telephone docking system of claim 1 wherein the dock unit contains a plurality of control buttons.

4. The mobile telephone docking system of claim 3 wherein depressing one of said control buttons on the dock unit mimics depressing a key on the cellular telephone.

5. The mobile telephone docking system of claim 1 further comprising a handheld remote unit that communicates with said dock unit.

6. The mobile telephone docking system of claim 1 wherein said dock unit contains at least one speaker.

7. The mobile telephone docking system of claim 1 wherein said dock unit includes a USB cable and an headphone cable, the USB cable and the headphone cable both adapted to interface into a cellular telephone.

8. The mobile telephone docking system of claim 1 wherein said API contains methods wherein an application running on the cellular telephone can control an attached dock unit.

9. The mobile telephone docking system of claim 1 wherein said API contains listener routines wherein an application running of the cellular telephone can ascertain status of the dock unit.

10. A cellular telephone dock system comprising:
a dock unit frame;
a slot on said frame adapted to receive a cellular telephone;
a first cable attached to said frame adapted to charge said cellular telephone's battery;
a second cable attached to said frame adapted to provide both an audio path and a data path between said dock unit and a docked cellular telephone;
wherein, said first cable includes a USB plug that interfaces with a USB port on a docked cellular telephone;
and wherein, said second cable includes a headphone jack that interfaces with a headphone jack on a docked cellular telephone;
an MCU located in said dock unit frame;
at least one button mounted on said dock unit frame, said button monitored by said MCU;
an alarm clock on said frame, said alarm clock under control of said MCU;
a cellular telephone application loaded into a docked cellular telephone, said application providing data communications between said docked cellular telephone and a program executing on said MCU.

11. The cellular telephone dock system of claim 10 further comprising an API available on said docked cellular telephone, said API providing method calls related to said dock system.

12. The cellular telephone dock system of claim 11 wherein said API provides methods that allow an application executing on said docked cellular telephone to control said audio path.

13. The cellular telephone dock system of claim 11 wherein said API provides methods that allow an application executing on said docked cellular telephone to control said alarm clock.

14. The cellular telephone dock system of claim 11 wherein said API provides command listeners that allow an application executing on said docked cellular telephone to monitor status of said button.

15. The cellular telephone dock system of claim 10 further comprising a remote handheld control unit in wireless communication with said MCU, said remote handheld control unit having a plurality of buttons.

16. The cellular telephone dock system of claim 10 wherein depressing buttons on said dock frame mimics pressing similar buttons on said docked cellular telephone.

17. A cellular telephone dock system comprising:
a dock frame;
a slot on said frame adapted to receive a cellular telephone;
at least one cable attached between said telephone and said dock frame;
at least one user button mounted on said dock frame or on a wireless remote unit in communication with said dock frame;
an application executing on a processor in said telephone, said application receiving information from a processor in said dock frame when said user button is depressed, said application then sending particular information to a remote server.

18. The cellular telephone dock system of claim 17 wherein said application gathers media metadata when said user button is depressed.

19. The cellular telephone dock system of claim 18 wherein said media metadata is the particular information sent to said remote server.

20. The cellular telephone dock system of claim 18 wherein said media metadata is at least partially gathered from a library on said telephone.
